(19) United States
(12) Patent Application Publication
(10) Pub. No.: US 2016/0064824 A1
(43) Pub. Date: Mar. 3, 2016

(54) ANTENNA CONSISTING OF AT LEAST TWO RADIATING TURNS AND AN EARTH PLANE

(71) Applicant: AVIWEST, SAINT GREGOIRE Cedex 9 (FR)

(72) Inventor: Jean-Michel MONTEIX, CESSON SEVIGNE (FR)

(21) Appl. No.: 14/778,319

(22) PCT Filed: Mar. 17, 2014
(86) PCT No.: PCT/EP2014/055308

§ 371 Date: Sep. 18, 2015

(30) Foreign Application Priority Data
Mar. 20, 2013 (FR) 13/52499

(51) Int. Cl. H01Q 9/04; H01Q 1/48

(52) U.S. Cl. CPC H01Q 9/0414; H01Q 1/48

(57) ABSTRACT

An antenna may include at least two radiating turns and an earth plane, wherein a first turn is placed opposite the earth plane so as to create a first resonant cavity, a second turn is folded several times so as to create at least one U shape forming at least one second resonant cavity and in that the resonant cavities are coupled to each other.

The present invention relates to an antenna intended to be used in mobile telecommunication devices.

Current portable telecommunication devices, such as for example mobile telephones, communicating tablets or remote metering devices, must be capable of transmitting and/or receiving signals in a plurality of frequency bands.

For example, the new telecommunication standard 3GPP LTE, also referred to as 4G, opens up a large number of frequency sub-bands in which the telecommunication devices must transmit and/or receive signals. The frequency sub-bands are between 700 MHz and 2700 MHz. The frequency sub-band 700 to 800 MHz, the frequency sub-band 824 to 960 MHz and the frequency sub-bands between 1710 MHz and 2700 MHz are examples.

The antenna or antennas of portable telecommunication devices must be able to transmit and/or receive electromagnetic signals in these frequency sub-bands. The lowest frequency sub-bands require large antennas while the miniaturisation of portable telecommunication devices imposes requirements of compactness on antennas.

The aim of the present invention is to solve these various constraints by proposing a multi-antenna system that is able to radiate and/or convert electromagnetic waves in a wide frequency spectrum while being compact.

To this end, according to a first aspect, the invention proposes an antenna consisting of at least two radiating turns and an earth plane, characterised in that a first turn is placed opposite the earth plane so as to create a first resonant cavity, a second turn is folded several times so as to create at least a U shape forming at least one second resonant cavity and in that the resonant cavities are coupled to each other.

Thus the antenna is able to radiate and/or convert electromagnetic waves in a broad frequency spectrum while being compact.

The combination of turns, resonant cavities and strong coupling between the resonant cavities enables the antenna to cover a much greater frequency band than that obtained by coupling a conventional antenna with a parasitic element or with another antenna while being compact.

The combination of turns, resonant cavities and strong coupling between the resonant cavities gives the antenna very great stability of matching when the radiating elements are subjected to a close environment different from open space, such as a finger or a head or close to metal elements. The antenna according to the present invention is suitable for being fitted in any small object, such as a mobile telephone, a PDA, a USB key, a tablet or a portable computer functioning close to human bodies.

In addition, the antenna according to the present invention is insensitive to the resizing of the earth plane or to the installation of new shielding.

According to a particular embodiment of the invention, the distance between the first turn and the earth plane is between λ/10 and λ/30 and the opening of the second cavity has a width of between λ/10 and λ/300, where λ is the greatest length of the electromagnetic waves transmitted and/or received by the antenna.

According to a particular embodiment of the invention, the resonant cavities are distant from each other by λ/10 to λ/30.

According to a particular embodiment of the invention, the first and second turns are coplanar with the earth plane or with one element of the earth plane.

According to a particular embodiment of the invention, the first turn is parallel to one of the edges of the earth plane or to the element of the earth plane.

According to a particular embodiment of the invention, the second turn is folded in order to form several U shapes.

According to a particular embodiment of the invention, the antenna consists of three radiating turns, and the third turn is folded several times so as to create at least one U shape forming at least one third resonant cavity.

According to a particular embodiment of the invention, the size of the first turn and the distance of the first turn with respect to the earth plane are suitable for the electromagnetic waves transmitted and/or received having the shortest wavelengths.

According to a particular embodiment of the invention, the size and the folds of the second turn are suitable at least for the electromagnetic waves transmitted and/or received having the longest wavelengths.

The features of the invention mentioned above, as well as others, will emerge more clearly from a reading of the following description of an example embodiment, said description being given in relation to the accompanying drawings, among which:

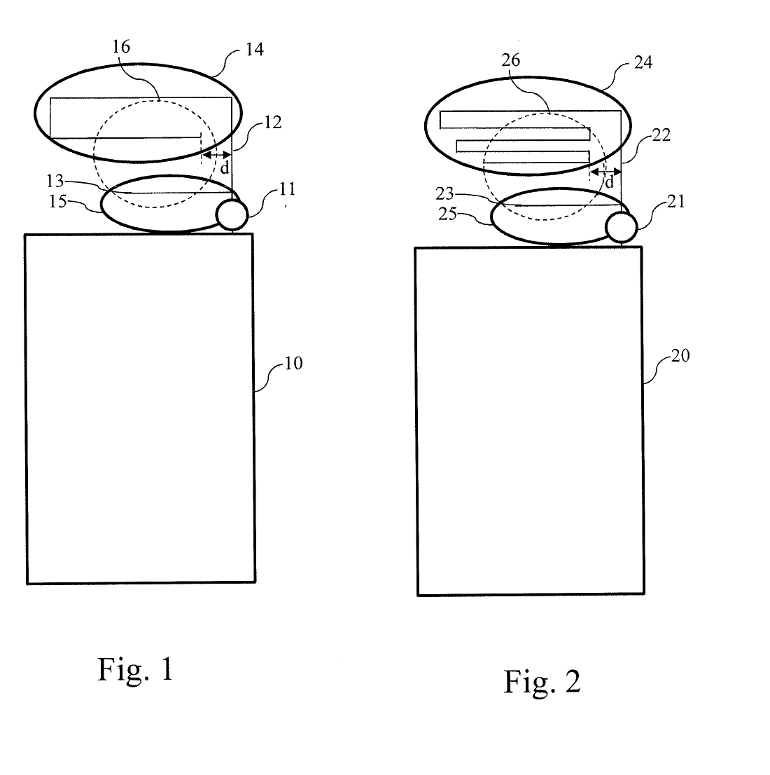

FIG. 1 depicts a first example embodiment of an antenna according to the present invention;

FIG. 2 depicts a second example embodiment of an antenna according to the present invention;

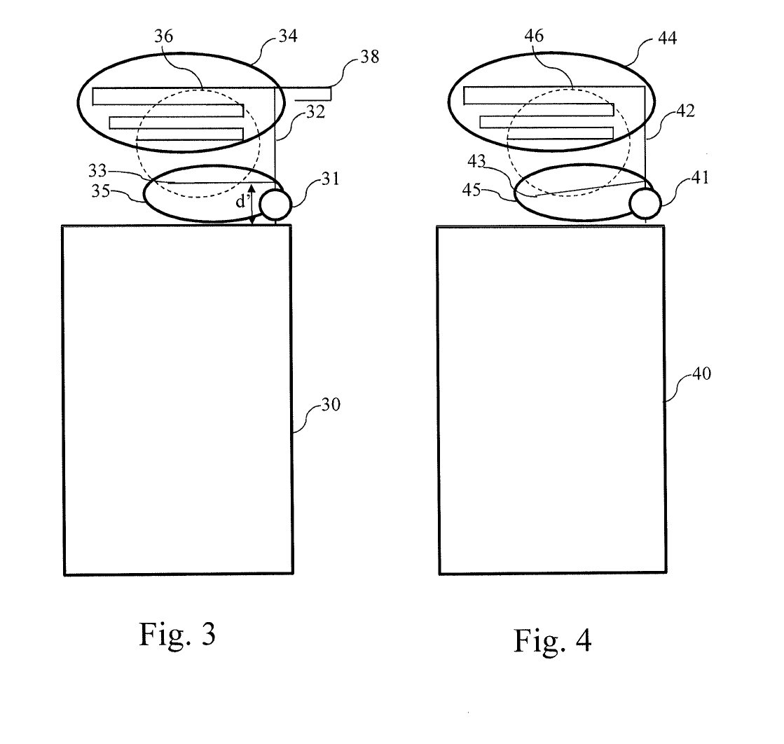

FIG. 3 depicts a third example embodiment of an antenna according to the present invention;

FIG. 4 depicts a fourth example embodiment of an antenna according to the present invention;

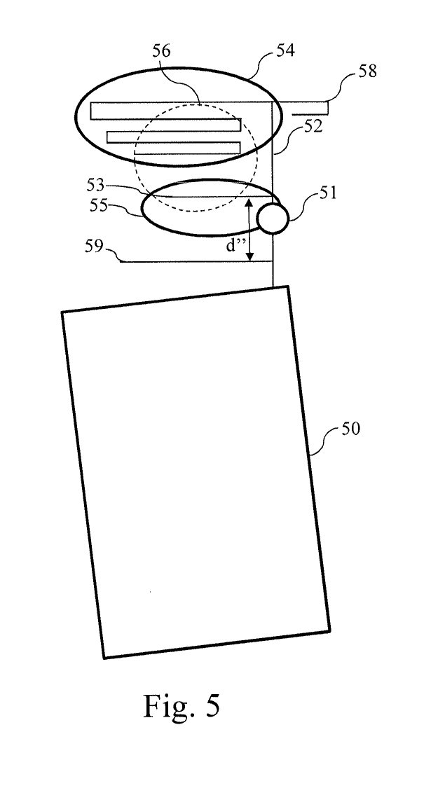

FIG. 5 depicts a fifth example embodiment of an antenna according to the present invention;

FIG. 1 depicts a first example embodiment of an antenna according to the present invention.

The antenna consists of two radiating turns 12 and 13 connected by means of a connection 11 to a modem, not shown in FIG. 1, which generates the electrical signals that the antenna must transmit and processes the radio signals received by the antenna.

The turns 12 and 13 are for example coplanar with the earth plane 10.

The modem is connected to an earth plane 10.

The earth plane 10 is for example a circuit or a metal box.

The turn 13 is parallel to one of the sides of the earth plane 10 so as to create a first resonant cavity 15.

The turn 12 is folded several times so as to create a U shape forming a second resonant cavity 14.

The coupling 16 between the resonant cavities 14 and 15 makes it possible to obtain a broad range of functioning of the antenna.

The distance between the turn 13 and the earth plane 10 is between λ/10 and λ/30, where λ is the greatest length of the electromagnetic waves transmitted and/or received by the antenna.

The opening d of the resonant cavity 14 has a width of between λ/10 and λ/300 where λ, is the greatest length of the electromagnetic waves transmitted and/or received by the antenna.

The resonant cavities 14 and 15 are distant from each other by λ/10 to λ/30.

The antenna according to the present invention is able to function in frequency ranges such as 824-960 MHz and 1710-2700 MHZ or more, or 700-824 MHz and 1710-2700 MHz or the frequency band used for WiFi at 5 GHz.

The dimensions and forms of the turns 12 and 13 are determined so as to achieve a strong capacitive coupling between the resonant cavities 14 and 15.

The location of the cavities 14 and 15, the location of the areas of strong coupling present at the opening d of each cavity 14 and 15 and the location of the coupling zone 16 as well as the minimum distance between these various zones, depend on the resonant frequencies required for the elements of the antenna. These locations depend on the distribution of the currents at the frequencies in question. This is because, for each of the cavities 14 and 15 coupled with each other, the most balanced current distribution is obtained in order at a minimum to double the width of the high sub-band covered, which is for example 1710-2700 MHz for one of the turns. This effect may be considered to be similar to that employed by certain broadband antenna networks, without giving rise to directivity of the radiation diagram, or that obtained by a broadband antenna that is large compared with the antenna described here.

The distributions of current on the turns are dependent on the structure of the antenna and of the earth plane 10.

FIG. 2 depicts a second example embodiment of an antenna according to the present invention.

The antenna consists of two radiating turns 22 and 23 connected by means of a connection 21 to a modem.

The turns 22 and 23 are for example coplanar with the earth plane 20.

The modem is connected to an earth plane 20.

The earth plane 20 is for example a circuit or a metal box.

The turn 23 is parallel to one of the sides of the earth plane 20 so as to create a first resonant cavity 25.

The turn 22 is folded several times so as to create a plurality of successive U shapes. Each U corresponds to the formation of a resonant cavity. All the resonant cavities are denoted 24 in FIG. 2.

The coupling 26 between the resonant cavities 24 and 25 makes it possible to obtain a wide functioning range of the antenna.

The distance between the turn 23 and the earth plane 20 is between λ/10 and λ/30 where λ is the greatest length of the electromagnetic waves transmitted and/or received by the antenna.

The openings of the resonant cavities formed by the Us have a width of between λ/10 and λ/300. It should be noted here that the openings may have different sizes compared with one another.

The resonant cavities 24 and 25 are distant from each other by λ/4 and λ/30.

FIG. 3 depicts a third example embodiment of an antenna according to the present invention.

The antenna consists of three radiating turns 32, 33 and 38 connected by means of a connection 31 to a modem.

The turns 32, 33 and 34 are for example coplanar with the earth plane 30.

The modem is connected to an earth plane 30.

The earth plane 30 is for example a circuit or a metal box.

The turn 33 is parallel to one of the sides of the earth plane 20 so as to create a first resonant cavity 35.

The turn 32 is folded several times so as to create a plurality of successive U shapes. Each U contributes to the formation of a resonant cavity. All the resonant cavities are denoted 34 in FIG. 3.

The coupling 36 between the resonant cavities 34 and 35 makes it possible to obtain a broad functioning range of the antenna.

The distance between the turn 33 and the earth plane 30 is between λ/10 and λ/300, where λ is the greatest length of the electromagnetic waves transmitted and/or received by the antenna.

The turn 38 is folded several times so as to create at least one U shape forming at least one other resonant cavity that is only weakly or not at all coupled to the other resonant cavities.

The openings of the resonant cavities formed by the Us have a width of between λ/10 and λ/300. It should be noted here that the openings may have different sizes with respect to one another.

FIG. 4 shows a fourth example embodiment of an antenna according to the present invention.

The elements denoted 40 to 46 in FIG. 4 are identical to the elements noted 20 to 26 in FIG. 2.

The antenna in FIG. 4 is identical to the antenna as described with reference with FIG. 2 with the only difference that the angle of inclination of the turn 23 in FIG. 2, and noted 43 in FIG. 4, makes it possible to vary the characteristics of the cavity between the earth plane 10 and the turn 33 and the coupling 46 between the two cavities 45 and 46.

This angle is for example between 0 and 20 degrees.

FIG. 5 shows a fifth example embodiment of an antenna according to the present invention.

The antenna consists of two radiating turns 52 and 53 connected by means of a connection 51 to a modem.

The turns 22 and 23 are for example coplanar with the earth plane 50 and with an element 59 of the earth plane 50 or are for example coplanar with the element 59 of the earth plane 50.

The modem is connected to an earth plane 50 and to the element 59 of the earth plane 50.

The earth plane 50 is for example a circuit or a metal box.

The turn 53 is parallel to the element 59 of the earth plane 50, the earth plane 50 being parallel or not to the element 59.

The turn 53 is parallel to the element 59 of the earth plane 50 so as to create a first resonant cavity 55.

The turn 52 is folded several times so as to create a plurality of successive U shapes. Each U contributes to the formation of a resonant cavity. All the resonant cavities are denoted 54 in FIG. 5.

The coupling 56 between the resonant cavities 54 and 55 makes it possible to obtain a broad functioning range or the antenna.

The distance between the turn 53 and the earth plane 50 is between λ/10 and λ/30 where λ is the greatest length of the electromagnetic waves transmitted and/or received by the antenna.

The openings of the resonant cavities formed by the Us have a width of between λ/10 and λ/300. It should be noted here that the openings may be of different sizes with respect to one another.

The resonant cavities 54 and 55 are distant from each other by λ/4 to λ/30.

Naturally the present invention is in no way limited to the embodiments described here but quite the contrary encompasses any variant within the capability of a person skilled in the art and particularly the combination of various embodiments of the present invention.

1. An antenna comprising:
at least two radiating turns; and
an earth plane,
wherein:
a first turn is placed opposite the earth plane so as to create a first resonant cavity,
a second turn is folded several times so as to create at least one U shape forming at least one second resonant cavity, and
in that the resonant cavities are coupled to each other, the distance between the first turn and the earth plane is between λ/10 and λ/30 and the opening of the second cavity has a width of between λ/10 and λ/300, where λ is the greatest length of the electromagnetic waves transmitted and/or received by the antenna.

2. The antenna according to claim 1, wherein the resonance cavities are distant from each other by λ/4 to λ/30.

3. The antenna according to claim 1, wherein the first and second turns are coplanar with the earth plane or with an element of the earth plane.

4. The antenna according to claim 3, wherein the first turn is parallel to one of the edges of the earth plane or to the element of the earth plane.

5. The antenna according to claim 1, wherein the second turn is folded in order to form several U shapes.

6. The antenna according to claim 1, wherein the antenna consists of three radiating turns, and the third turn is folded several times so as to create at least one U shape forming at least one resonant cavity.

7. The antenna according to claim 1, wherein the size of the first turn and the distance of the first turn with respect to the earth plane are suitable for the transmitted and/or received electromagnetic waves having the shortest wavelengths.

8. The antenna according to claim 1, wherein the size and the folds of the second turn are suitable at least for the transmitted and/or electromagnetic waves having the longest wavelengths.
